(19) United States
(12) Patent Application Publication
(10) Pub. No.: US 2026/0080088 A1
(43) Pub. Date: Mar. 19, 2026

(54) SYSTEMS AND METHODS FOR TRANSPARENT MANAGEMENT OF TIERED STORAGE MEDIA

(71) Applicant: Netflix, Inc., Los Gatos, CA (US)

(72) Inventors: Alexander Chychykalo, Seattle, WA (US); Pramod Hegde, Cambridge, MA (US); Anthony Vardaro, Los Angeles, CA (US); Daniel Darin Peshev, New York, NY (US); Vikram Harakere Krishnamurthy, Los Gatos, CA (US)

(21) Appl. No.: 19/327,450

(22) Filed: Sep. 12, 2025

Related U.S. Application Data
(60) Provisional application No. 63/694,396, filed on Sep. 13, 2024.

(51) Int. Cl. G06F 21/62

(52) U.S. Cl. CPC G06F 21/6218

(57) ABSTRACT

A system for transparent management of tiered storage media includes tiered storage media and circuitry communicatively coupled to the tiered storage media. In one example, the circuitry is configured to implement a storage layer comprising a data movement engine and a unified storage interface. In this example, the circuitry is configured to transparently transfer, by the data movement engine, a portion of the data between the high-performance tier and the low-performance tier based at least in part on a storage policy applied to the tiered storage media. Additionally or alternatively, the circuitry is configured to provide, by the unified storage interface, at least one of the applications with access to the portion of the data. Various other methods, systems, and computer-readable media are also disclosed.

### CROSS REFERENCE TO RELATED APPLICATION

This application claims the benefit of U.S. Provisional Application No. 63/694,396 filed Sep. 13, 2024, the disclosure of which is incorporated in its entirety by this reference.

### BACKGROUND

In modern cloud-based computing environments, applications often access large volumes of data for a variety of workloads, such as media streaming, analytics, and enterprise operations. To meet diverse performance and cost requirements, these environments can employ tiered storage architectures. Some conventional approaches to managing tiered storage media involve application developers or system operators that manually configure, provision, and/or manage storage resources for each workload. Such manual management can lead to suboptimal data placement, increased operational complexity, and/or reduced efficiency. Unfortunately, in these conventional approaches, some applications may need to be aware of the underlying storage types within the tiered storage architectures and/or to explicitly handle data movement between the corresponding storage tiers.

The instant disclosure, therefore, identifies and addresses a need for improved systems and methods for transparent management of tiered storage architectures.

### SUMMARY

As will be described in greater detail below, the present disclosure describes systems and methods for transparent management of tiered storage media. In some examples, a system for transparent management of tiered storage media includes tiered storage media and circuitry communicatively coupled to the tiered storage media. In one example, the circuitry is configured to implement a storage layer comprising a data movement engine and a unified storage interface. In this example, the circuitry is configured to transparently transfer, by the data movement engine, a portion of the data between the high-performance tier and the low-performance tier based at least in part on a storage policy applied to the tiered storage media. Additionally or alternatively, the circuitry is configured to provide, by the unified storage interface, at least one of the applications with access to the portion of the data.

In some examples, the at least one of the applications is unaware of the transparent transfer of the portion of the data between the high-performance tier and the low-performance tier. In one example, the unified storage interface receives, from the at least one of the applications, a request to read the portion of the data via a standard protocol and then obtains the portion of the data from the tiered storage media. In this example, the unified storage interface transmits the portion of the data to the at least one of the applications via a network to satisfy the request.

In some examples, the unified storage interface initiates the transmission of the portion of the data upon determining that the at least one of the applications is authorized to access the portion of the data. In one example, the unified storage interface receives, from the at least one of the applications, a request to write an additional portion of the data to the tiered storage media via a standard protocol and then provides the request to the data movement engine. In this example, the data movement engine writes the additional portion of the data to the tiered storage media to satisfy the request.

In some examples, the storage layer further comprises a provisioning engine, and the circuitry is further configured to automatically provision, by the provisioning engine, an area of the tiered storage media for the at least one of the applications based at least in part on characteristics of the at least one of the applications. In one example, the circuitry is further configured to automatically provision, by the provisioning engine, another area of the tiered storage media for another one of the applications based at least in part on characteristics of the another one of the applications.

In some examples, the data movement engine stores a subset of the data corresponding to the at least one of the applications in the area of the tiered storage media. In one example, the data movement engine stores another subset of the data corresponding to the another one of the applications in the another area of the tiered storage media.

In some examples, the data movement engine monitors usage patterns of the portion of the data and transparently transfers the portion of the data from the high-performance tier to the low-performance tier or from the low-performance tier to the high-performance tier based at least in part on the storage policy, usage patterns of the portion of the data, and one or more workload considerations of the at least one of the applications. In one example, the storage layer comprises a metadata manager, and the circuitry is further configured to generate, by the metadata manager, metadata associated with the portion of the data. In this example, the circuitry is further configured to store, by the metadata manager, the metadata at multiple storage devices to ensure high availability of the portion of the data and locate, by the unified storage interface or the data movement engine, the portion of the data based at least in part on the metadata.

In some examples, the metadata identifies at least one of a current location at which the portion of the data is stored in the tiered storage media, a state of the portion of the data, and/or an access history of the portion of the data. In one example, the storage layer further comprises an analytics engine and a dashboard interface. In this example, the circuitry is further configured to aggregate, by the analytics engine from multiple agents running on the compute nodes, metadata associated with operations performed in connection with the portion of the data and to provide the metadata for presentation via the dashboard interface.

In some examples, a computer-implemented method for transparent management of tiered storage media includes (1) implementing, by circuitry, a storage layer in a tiered storage media that includes a high-performance tier and a low-performance tier, (2) storing, by a data movement engine of the storage layer in the tiered storage media, data corresponding to applications that are running on compute nodes and are agnostic to the high-performance tier and the low-performance tier, (3) transparently transferring, by the data movement engine, a portion of the data between the high-performance tier and the low-performance tier based at least in part on a storage policy applied to the tiered storage media, and (4) providing, by a unified storage interface of the storage layer, at least one of the applications with access to the portion of the data. In some examples, the at least one of the applications is unaware of the transparent transfer of the portion of the data between the high-performance tier and the low-performance tier.

In some examples, a non-transitory computer-readable medium includes one or more computer-executable instructions that, when executed by circuitry of a computing device, cause the computing device to (1) implement a storage layer in a tiered storage media that includes a high-performance tier and a low-performance tier, (2) store, by a data movement engine of the storage layer in the tiered storage media, data corresponding to applications that are running on compute nodes and are agnostic to the high-performance tier and the low-performance tier, (3) transparently transfer, by the data movement engine, a portion of the data between the high-performance tier and the low-performance tier based at least in part on a storage policy applied to the tiered storage media, and (4) provide, by a unified storage interface of the storage layer, at least one of the applications with access to the portion of the data.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for transparent management of tiered storage media in accordance with one or more implementations of this disclosure.

FIG. 2 illustrates an exemplary system for transparent management of tiered storage media in accordance with one or more implementations of this disclosure.

FIG. 3 illustrates an exemplary method for transparent management of tiered storage media in accordance with one or more implementations of this disclosure.

FIG. 4 illustrates a block diagram of an exemplary content distribution ecosystem.

FIG. 5 illustrates a block diagram of an exemplary distribution infrastructure within the content distribution ecosystem shown in FIG. 4.

FIG. 6 illustrates a block diagram of an exemplary content player within the content distribution ecosystem shown in FIG. 4.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to systems and methods for transparent management of tiered storage media. As will be explained in greater detail below, these systems and methods can provide numerous features and benefits over conventional technologies, such as simplicity for application developers, automated data tiering, improved cost efficiency of tiered storage media, improved performance of tiered storage media, centralized observability or management of data, enhanced security and access control, increased availability or reliability of data, scalability, plug-and-play portability, etc.

In some examples, these systems and methods provide a smarter way for applications to store and/or access their data in cloud and/or distributed computing environments. For example, instead of requiring each application to know where its data is stored or to manage different types of storage, a system can introduce a storage layer that automatically handles data storage, management, caching, and/or retrieval behind the scenes. In this example, data is kept on different types of storage-fast, high-performance storage for frequently used information and slower, more affordable storage for less-used data.

In some examples, the system monitors how each application uses its data and/or moves such data between the different storage types to optimize the performance and/or cost efficiency of tiered storage media in view of the workload and/or performance needs of each application. For example, a data movement engine of the storage layer transparently manages and/or moves applications' data within the tiered storage media without the applications being aware of such management and/or movement. In this example, when an application needs to read or write data, the application simply makes a standard request to a unified storage interface of the storage layer. In certain implementations, the unified storage interface receives the request, locates the corresponding data, and/or delivers such data to the application.

In some examples, the storage layer also automatically allocates and/or configures the right kind of storage for each application based on its workload intent and/or performance requirements. In one example, the storage layer tracks the locations of all the data in the tiered storage media, data usage patterns, and/or which applications are allowed to access the data. In certain implementations, the system also provides a dashboard that shows how the tiered storage media or managed data is used across all the applications, thus enabling administrators to monitor performance, identify issues, and/or manage resources at scale and/or in the aggregate. Accordingly, this system simplifies the complexity and/or increases efficiency of data storage from the applications' perspective while reducing costs and improving reliability for large-scale computing environments.

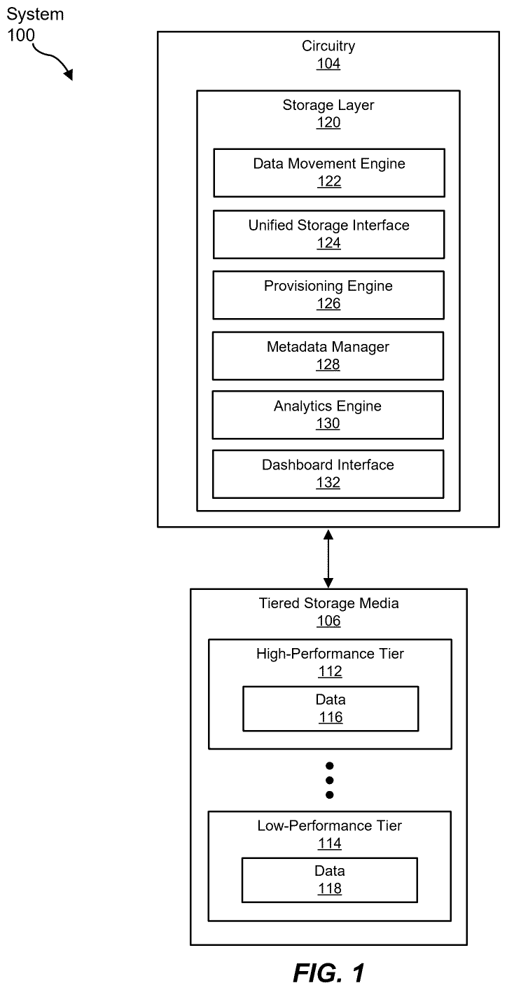

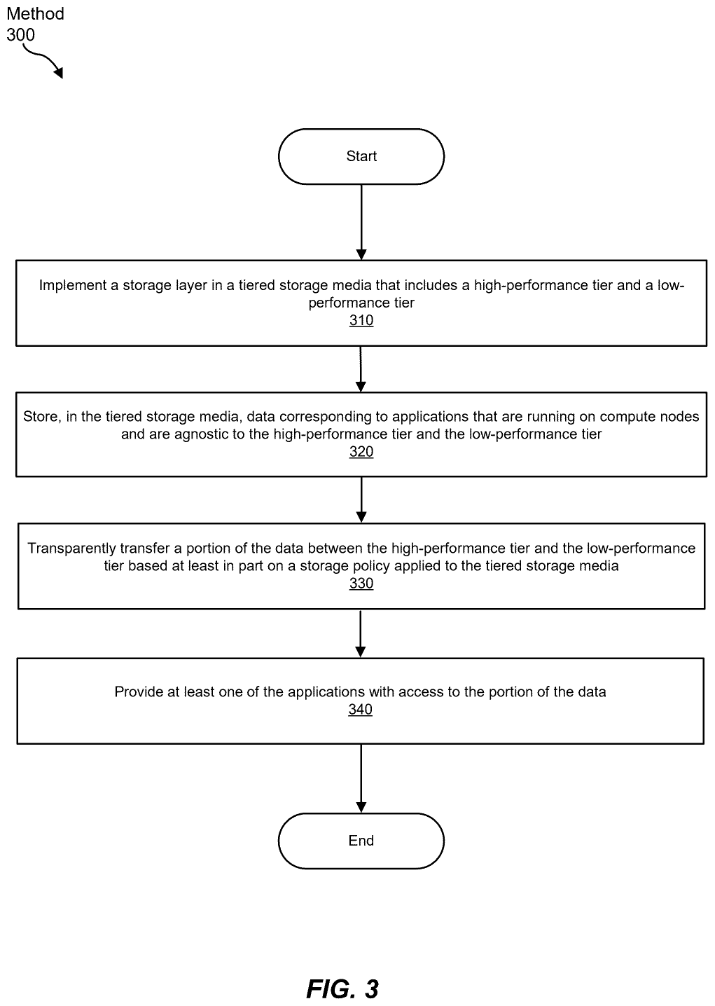

The following will provide, with reference to FIGS. 1-2 and 4-6, detailed descriptions of exemplary devices, systems, and corresponding implementations or configurations that facilitate and/or support transparent management of tiered storage media. The following will also provide, with reference to FIG. 3, examples of methods for transparent management of tiered storage media.

FIG. 1 illustrates an exemplary system 100 for transparent management of tiered storage media. In some examples, system 100 includes and/or represents circuitry 104 and/or a tiered storage media 106. In one example, circuitry 104 and/or tiered storage media 106 interface with and/or are communicatively coupled to one another. In this example, tiered storage media 106 includes and/or represents multiple tiers of storage, such as high-performance tier 112 and/or low-performance tier 114. In certain implementations, tiered storage media 106 and circuitry 104 can be independent and/or separate from one another. Additionally or alternatively, although not necessarily illustrated in this way in FIG. 1, tiered storage media 106 can include and/or incorporate some or all of circuitry 104.

In some examples, high-performance tier 112 stores, keeps, and/or maintains data 116, and low-performance tier 114 stores, keeps, and/or maintains data 118. In one example, data 116 and/or data 118 can belong to, correspond to, be associated with, and/or be used by one or more applications running on compute nodes within a cloud-based computing environment. In certain implementations, data 116 includes and/or represents hot data that is frequently used by one or more of those applications, and data 118 includes and/or represent cold data that is infrequently and/or less frequently used by one or more of those applications. Additionally or alternatively, some or all of data 116 and/or data 118 can include and/or represent streaming media destined for presentation on an end-user device.

In some examples, circuitry 104 provides, executes, and/or implements a storage layer 120 responsible for managing, tracking, maintaining, moving, accessing, storing, deleting, and/or delivering data in connection with tiered storage media 106. In one example, storage layer 120 includes and/or represents various components and/or features, such as a data movement engine 122, a unified storage interface 124, a provisioning engine 126, a metadata manager 128, an analytics engine 130, and/or a dashboard interface 132. In certain implementations, data movement engine 122 transparently transfers and/or moves some of data 116 and/or data 118 between and/or across high-performance tier 112 and/or low-performance tier 114. For example, data movement engine 122 can transparently transfer and/or move some of data 116 from high-performance tier 112 to low-performance tier 114 based at least in part on a storage policy applied to tiered storage media 106. Additionally or alternatively, data movement engine 122 can transparently transfer and/or move some of data 118 from low-performance tier 114 to high-performance tier 112 based at least in part on the storage policy applied to tiered storage media 106.

In some examples, the transparency of such transfers refers to and/or represents the automatic movement of data between different storage tiers (e.g., from high-performance tier 112 to low-performance tier 114 or vice versa) without the applications to which such data corresponds being aware of and/or agnostic to the transfer process. Accordingly, the applications may be unaware of and/or agnostic to the transparent transfers performed between high-performance tier 112 and low-performance tier 114. In one example, transparent transfers are triggered and/or initiated in response to the detection of certain characteristics and/or parameters of the applications and/or the underlying data. For example, data movement engine 122 can initiate and/or perform a transparent transfer between high-performance tier 112 and low-performance tier 114 based at least in part on the workload intent and/or performance requirements of one of the applications in view of the storage policy.

In some examples, unified storage interface 124 provides certain applications with access to some of data 116 and/or data 118. For example, when an application needs to access certain data, the application sends an input/output (I/O) request—such as a read or write request—to unified storage interface 124. In this example, unified storage interface 124 can receive this I/O request from the application via a standard protocol, such as a file system application programming interface (API) and/or an object storage API. Upon receiving the I/O request, unified storage interface 124 consults metadata to determine the current location of the requested data within tiered storage media 106.

In some examples, if the data is already present in high-performance tier 112, unified storage interface 124 retrieves the requested data directly from high-performance tier 112. In one example, if the data resides in low-performance tier 114, unified storage interface 124 coordinates with data movement engine 122 to fetch the requested data from low-performance tier 114 and/or to promote the requested data to high-performance tier 112 in accordance with the storage policy. Either way, upon locating and/or obtaining the requested data, unified storage interface 124 provides and/or delivers the requested data to the application via a network. By doing so, unified storage interface 124 is able to fulfil and/or satisfy the I/O request. Throughout this process, the application remains unaware of and/or agnostic to the data's physical location or any data movement that has occurred between high-performance tier 112 and low-performance tier 114, thereby experiencing seamless and/or efficient access to the requested data.

In some examples, storage layer 120 controls access to data 116 and data 118, thereby ensuring that only authorized applications and/or users are able to retrieve or modify data 116 and data 118 stored in tiered storage media 106. For example, when an application submits an I/O request to access data stored in tiered storage media 106, unified storage interface 124 authenticates the identity of the requesting application and/or user via credentials, tokens, and/or other security measures. In this example, unified storage interface 124 evaluates the request against the storage policy and/or established access control policies. In certain implementations, the storage and/or access control policies include and/or represent access control lists (ACLs), role-based access control (RBAC) models, and/or other policy-based rules that define which entities are authorized and/or allowed to access specific data.

In some examples, if the requesting application is so authorized, storage layer 120 proceeds to fulfill the request and/or provide access to the data. However, if the requesting application is not so authorized, storage layer 120 rejects and/or denies the access attempt and/or returns an appropriate error or denial message to the application without providing access to the data. In one example, storage layer 120 performs this enforcement of access control transparently and consistently, thereby ensuring that sensitive or restricted data remains protected from unauthorized access. Additionally or alternatively, storage layer 120 can log all access attempts—both successful and unsuccessful—for auditing and compliance purposes, further strengthening the security of tiered storage media 106.

In some examples, when an application needs to store new or updated data, the application issues a write request to unified storage interface 124 via a standard protocol, such as a file system API and/or an object storage API. In one example, unified storage interface 124 serves as the entry point for all such requests to abstract the complexity of tiered storage media 106. In this example, upon receiving the write request, unified storage interface 124 forwards the write request to data movement engine 122.

In some examples, data movement engine 122 evaluates the request and then determines the optimal location in tiered storage media 106 to store the new or updated data based at least in part on storage policies, data usage patterns, and/or workload and/or performance requirements of the requesting application. In one example, data movement engine 122 performs the actual write operation, ensuring that the new or updated data is stored in the appropriate tier (e.g., high-performance tier 112 for frequently accessed data or low-performance tier 114 for less frequently accessed data). This division of responsibilities between data movement engine 122 and unified storage interface 124 enables storage layer 120 and/or system 100 to improve and/or optimize storage efficiency or performance while maintaining a seamless and/or transparent experience for the requesting application.

In some examples, when an application requires storage resources, provisioning engine 126 automatically provisions an area of tiered storage media 106 for the application based at least in part on characteristics (e.g., the workload intent and/or performance requirements) of the application in view of the storage policy. In one example, when another application requires storage resources, provisioning engine 126 automatically provisions another area of tiered storage media 106 for the other application based at least in part on characteristics of the other application. This automated provisioning by provisioning engine 126 enables storage layer 120 and/or system 100 to allocate and/or configure storage resources efficiently and responsively to be tailored to the specific needs and/or workload requirements of each application without requiring manual configuration by any of the applications themselves.

In some examples, data movement engine 122 stores a subset of data 116 and/or data 118 corresponding to the application in the area of tiered storage media 106 provisioned for that application. In one example, data movement engine 122 stores another subset of data 116 and/or data 118 corresponding to the other application in the other area of tiered storage media 106 provisioned for that other application. This storage approach enables storage layer 120 and/or system 100 to maintain logical separation and/or efficient management of data for each application within tiered storage media 106.

In some examples, data movement engine 122 monitors usage patterns of the data 116 and/or data 118 in connection with the corresponding applications. In one example, data movement engine 122 transparently transfers some or all of data 116 from high-performance tier 112 to low-performance tier 114 based at least in part on the storage policy, usage patterns of such data, and/or one or more workload considerations (e.g., workload intent, performance requirements, etc.) of the application. Additionally or alternatively, data movement engine 122 transparently transfers some or all of data 118 from low-performance tier 114 to high-performance tier 112 based at least in part on the storage policy, usage patterns of such data, and/or one or more workload considerations of the application. This dynamic, policy-driven data movement enables storage layer 120 and/or system 100 to optimize data placement for performance and/or cost efficiency while maintaining seamless experience and/or access for the applications.

In some examples, metadata manager 128 generates metadata associated with data 116 and/or data 118 corresponding to the applications. In one example, metadata manager 128 stores the metadata at multiple storage devices to ensure high availability of data 116 and/or data 118. Additionally, metadata manager 128 enables unified storage interface 124 or data movement engine 122 to locate certain data in tiered storage media 106 based at least in part on the metadata. This approach enables storage layer 120 and/or system 100 to maintain reliable access and efficient management of data within tiered storage media 106 even in distributed or high-availability environments. Examples of such metadata include, without limitation, current locations where the data is stored in the tiered storage media, states of the data, access history of the data, usage patterns and/or statistics associated with the data, combinations of one or more of the same, and/or any other suitable metadata.

In some examples, analytics engine 130 aggregates and/or collects metadata associated with I/O operations (e.g., read/write requests, data movement, cache hits/misses, latency, errors, health indicators, metrics, events, etc.) from multiple agents running on the compute nodes. Additionally or alternatively, analytics engine 130 provides the metadata for the purpose of handling the administration of data between high-performance tier 112 and low-performance tier 114. For example, data movement engine 122 may decide and/or opt to delete unnecessary data from high-performance tier 112 based at least in part on the metadata (e.g., if such data is present on low performance tier 114).

In one example, such I/O operations may be performed in connection with data 116 and/or data 118 stored in tiered storage media 106. In this example, dashboard interface 132 provides the aggregated metadata for presentation and/or display to an administrator and/or user. By doing so, dashboard interface 132 and/or system 100 provides centralized observability to monitor, analyze, and/or visualize storage operations and/or health across distributed computing environments to support efficient management and/or troubleshooting.

In some examples, circuitry 104 includes and/or represents one or more electrical and/or electronic circuits capable of processing, applying, modifying, transforming, displaying, transmitting, receiving, and/or executing data for system 100. In one example, circuitry 104 executes, provides, and/or implements storage layer 120 and/or its subcomponents. In this example, circuitry 104 accesses, analyzes, and/or moves data stored in tiered storage media 106 to facilitate and/or support transparent management of tiered storage media. Additionally or alternatively, circuitry 104 launches, performs, and/or executes certain executable files, code snippets, and/or computer-readable instructions to facilitate and/or support transparent management of tiered storage media.

Although illustrated as a single unit in FIG. 1, circuitry 104 can include and/or represent a collection of multiple processing units and/or electrical or electronic components that work and/or operate in conjunction with one another. Examples of circuitry 104 include, without limitation, processing devices, hardware processors, microprocessors, microcontrollers, field-programmable gate arrays (FPGAs), application-specific integrated circuits (ASICs), graphics processing units (GPUs), central processing units (CPUs), systems on chips (SoCs), parallel accelerated processors, tensor cores, integrated circuits, chiplets, receivers, transmitters, transceivers, storage devices, memory devices, digital logic, analog circuitry, digital circuitry, portions of one or more of the same, variations or combinations of one or more of the same, and/or any other suitable circuitry. In certain implementations, circuitry 104 can be distributed across multiple devices (e.g., remote and/or network devices in a cloud-based computing environment).

In some examples, tiered storage media 106 includes and/or represents any type or form of volatile or non-volatile storage device or medium capable of storing data and/or computer-readable instructions. In one example, tiered storage media 106 includes and/or represents one or more computer-readable instructions, modules, programs, and/or applications. Examples of tiered storage media 106 include, without limitation, Random Access Memory (RAM), Read Only Memory (ROM), flash memory, Hard Disk Drives (HDDs), Solid-State Drives (SSDs), Non-Volatile Memory express (NVMe) drives, local or attached block storage devices, ephemeral storage devices, high-speed network-attached storage (NAS), cloud-based or on-premises object storage devices, standard or throughput-optimized block storage devices, cold storage or archival storage devices, optical disk drives, caches, variations or combinations of one or more of the same, and/or any other suitable memory. Although illustrated as a single unit in FIG. 1, tiered storage media 106 can alternatively include and/or represent a collection of multiple storage devices capable of storing and/or maintaining a plurality of queues and/or data corresponding to jobs loaded in those queues.

Examples of high-performance tier 112 in tiered storage media 106 include, without limitation, NVMe drives, SSDs, local or attached block storage devices, ephemeral storage devices, high-speed NAS devices, variations or combinations of one or more of the same, and/or any other suitable high-performance storage devices. Examples of low-performance tier 114 in tiered storage media 106 include, without limitation, cloud-based or on-premises object storage devices, standard or throughput-optimized block storage devices, cold storage or archival storage devices, variations or combinations of one or more of the same, and/or any other suitable low-performance storage devices.

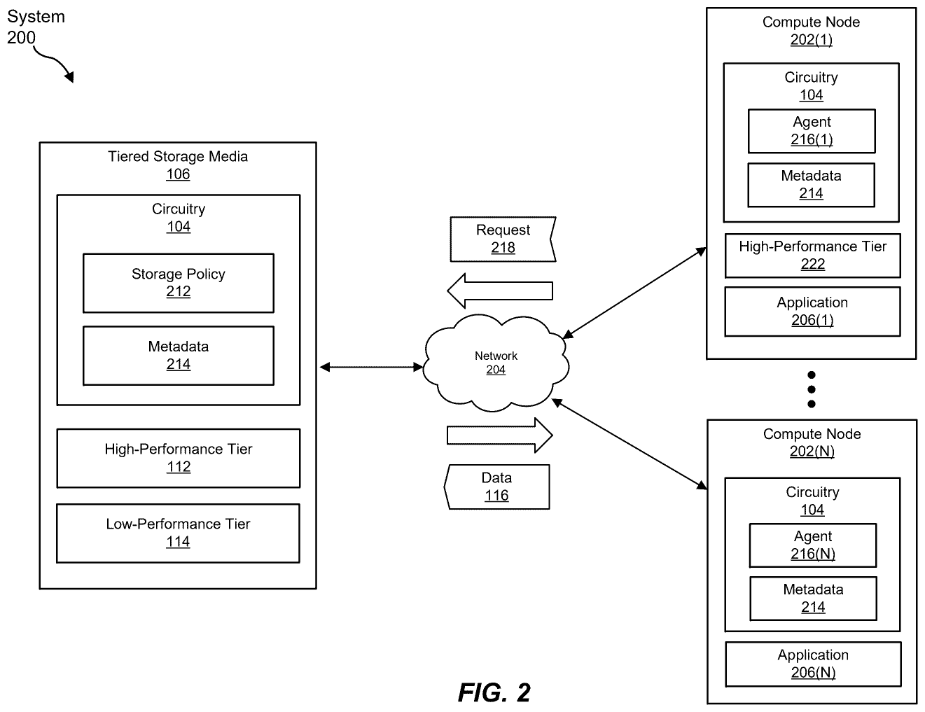

FIG. 2 illustrates an exemplary system 200 that facilitates and/or supports transparent management of tiered storage media. In some examples, system 200 in FIG. 2 includes and/or involves certain devices, components, configurations, and/or features that perform and/or provide functionalities that are similar and/or identical to those described above in connection with FIG. 1. In one example, system 200 includes and/or represents tiered storage media 106 communicatively coupled to compute nodes 202(1)-(N) via a network 204. In this example, tiered storage media 106 includes and/or represents high-performance tier 112, low-performance tier 114, and/or an instance and/or portion of circuitry 104.

In some examples, compute nodes 202(1)-(N) each include and/or represent an instance and/or portion of circuitry 104. In such examples, circuitry 104 can be implemented and/or distributed across tiered storage media 106, compute nodes 202(1)-(N), and/or system 100. In one example, compute nodes 202(1)-(N) execute and/or implement applications 206(1)-(N), respectively. Although FIG. 2 illustrates a single application running on each compute node, alternative implementations can involve multiple applications running on the same compute node.

In some examples, application 206(1) running on compute node 202(1) submits a request 218 to tiered storage media 106 via network 204. In one example, request 218 can include and/or represent a read request for specific data even though application 206(1) is unaware of where that data is stored in tiered storage media 106. As request 218 arrives at tiered storage media 106, unified storage interface 124 receives and processes request 218 by determining the appropriate location of the requested data. If the request is directed to a portion of data 116 located in high-performance tier 112, unified storage interface 124 or data movement engine 122 retrieves the corresponding portion of data 116 directly from high-performance tier 112 to fulfill the request. Once the requested data is retrieved, unified storage interface 124 or data movement engine 122 provides that portion of data 116 to application 206(1) running on compute node 202(1) via network 204. Throughout this process, application 206(1) remains unaware of the physical location of data 116 or any data movement that occurs between high-performance tier 112 and low-performance tier 114, thereby experiencing seamless and efficient access to the requested data.

In some examples, storage policy 212 is stored in, used by, and/or maintained by circuitry 104 of tiered storage media 106. In one example, storage policy 212 defines rules and criteria for managing data placement, movement, and/or retention across high-performance tier 112 and low-performance tier 114. For example, storage policy 212 may specify when and/or under which conditions data should be promoted to high-performance tier 112 based at least in part on access frequency. Similarly, storage policy 212 may specify when and/or under which conditions data should be demoted to low-performance tier 114 based at least in part on inactivity, cost considerations, and/or workload requirements. Additionally or alternatively, storage policy 212 can include and/or represent parameters for data retention, replication, and access control to enable storage layer 120 to optimize performance, cost, and reliability in accordance with organizational objectives.

In some examples, agents 216(1)-(N) run on instances of circuitry 104 implemented on compute nodes 202(1)-(N), respectively. In one example, each of agents 216(1)-(N) is responsible for monitoring and/or collecting metrics, events, and/or metadata 214 related to storage operations performed by the corresponding application running on the corresponding compute node. Agents 216(1)-(N) can report information such as I/O requests, data access patterns, latency, errors, and/or health indicators to analytics engine 130 of storage layer 120. This collected data enables centralized observability, troubleshooting, and optimization of storage operations across the distributed environment, and supports the presentation of aggregated insights via dashboard interface 132.

In some examples, portions of metadata 214 are distributed across tiered storage media 106 and/or compute nodes 202(1)-(N). In one example, portions of metadata 214 can be stored in, used by, and/or maintained by instances of circuitry 104 implemented on tiered storage media 106 and/or compute nodes 202(1)-(N). In certain implementations, metadata 214 include and/or represent information (e.g., the current location, the state, access history, usage patterns, etc.) associated with data 116 stored in high-performance tier 112 and/or data 118 stored in low-performance tier 114. Metadata 214 can enable efficient data retrieval, facilitate transparent data movement between storage tiers, and/or support high availability and reliability of data access for applications running on compute nodes 202(1)-(N).

In some examples, although not necessarily illustrated in this way in FIG. 2, one or more of compute nodes 202(1)-(N) can include and/or represent a high-performance tier. For example, compute node 202(1) can include and/or represent a high-performance tier 222. In one example, high-performance tier 222 incorporated in and/or implemented by compute node 202(1) can be synchronized with tiered storage media 106. In another example, high-performance tier 222 incorporated in and/or implemented by compute node 202(1) can operate and/or run independently of tiered storage media 106. Accordingly, a high-performance tier can be colocated in one or more of compute nodes 202(1)-(N).

In some examples, the various systems, components, and/or features described in connection with FIGS. 1-2 may include and/or represent one or more additional circuits, components, and/or features that are not necessarily illustrated and/or labeled in FIGS. 1-2. For example, the systems, components, and/or features illustrated in FIGS. 1-2 may also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, networks, combinations or variations of one or more of the same, and/or any other suitable components. In certain implementations, one or more of these additional circuits, components, and/or features may be inserted and/or applied between any of the existing circuits, components, and/or features illustrated in FIGS. 1-2 consistent with the aims and/or objectives described herein. Accordingly, the couplings and/or connections described with reference to FIGS. 1-2 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components constitutes and/or represents a coupling in which those two components are directly connected to each other by a single node that provides continuity from one of those two components to the other. In other words, the direct coupling excludes and/or omits any additional components between those two components.

Additionally or alternatively, an indirect coupling between two components constitute and/or represent a coupling in which those two components are indirectly connected to each other by multiple nodes that fail to provide continuity from one of those two components to the other. In other words, the indirect coupling includes and/or incorporates at least one additional component between those two components. In one example, the indirect coupling includes and/or incorporates at least one additional computing device between two computing devices illustrated in any of FIGS. 1-2. In some implementations, one or more components and/or devices illustrated in FIGS. 1-2 may be omitted and/or excluded from the corresponding systems.

FIG. 3 is a flow diagram of an exemplary computer-implemented method 300 for transparent management of tiered storage media. In one example, the steps shown in FIG. 3 are performed by circuitry incorporated in and/or implemented by one or more systems and/or computing devices, such as those described above in connection with FIGS. 1-2. Additionally or alternatively, the steps shown in FIG. 3 can include certain sub-steps, additional steps, and/or variations consistent with the descriptions provided above.

As illustrated in FIG. 3, method 300 includes the step of implementing a storage layer in a tiered storage media that includes a high-performance tier and a low-performance tier (step 310). Step 310 is performed in a variety of ways, including any of those described above in connection with FIGS. 1-2. For example, circuitry included in a system can implement a storage layer in tiered storage media. In this example, the storage layer can include and/or represent a data movement engine and/or a unified storage interface. Additionally or alternatively, the tiered storage media can include and/or represent high-performance tier and/or low-performance tier.

Method 300 also includes the step of storing, in the tiered storage media, data corresponding to applications that are running on compute nodes and are agnostic to the high-performance tier and the low-performance tier (step 320). Step 320 is performed in a variety of ways, including any of those described above in connection with FIGS. 1-2. For example, the data movement engine stores data in the tiered storage media. In this example, the data corresponds to applications that are running on compute nodes and are agnostic to the high-performance tier and the low-performance tier data.

Method 300 further includes the step of transparently transferring a portion of the data between the high-performance tier and the low-performance tier based at least in part on a storage policy applied to the tiered storage media (step 330). Step 330 is performed in a variety of ways, including any of those described above in connection with FIGS. 1-2. For example, the data movement engine transparently transfers a portion of data between the high-performance tier and the low-performance tier based at least in part on the storage policy.

Method 300 further includes the step of providing at least one of the applications with access to the portion of the data (step 340). Step 340 is performed in a variety of ways, including any of those described above in connection with FIGS. 1-2. For example, the unified storage interface provides at least one of the applications with access to the requested portion of data.

Furthermore, a non-transitory computer-readable medium comprises one or more computer-executable instructions that, when executed by circuitry incorporated in a computing system, cause the system to (1) implement a storage layer in a tiered storage media that includes a high-performance tier and a low-performance tier, (2) store, by a data movement engine of the storage layer in the tiered storage media, data corresponding to applications that are running on compute nodes and are agnostic to the high-performance tier and the low-performance tier, (3) transparently transfer, by the data movement engine, a portion of the data between the high-performance tier and the low-performance tier based at least in part on a storage policy applied to the tiered storage media, and (4) provide, by a unified storage interface of the storage layer, at least one of the applications with access to the portion of the data.

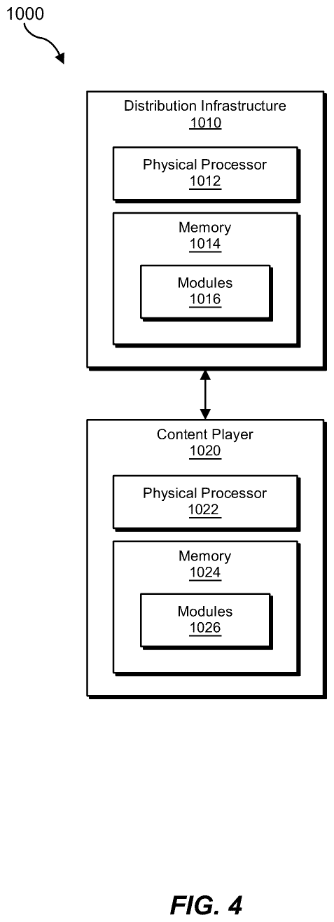

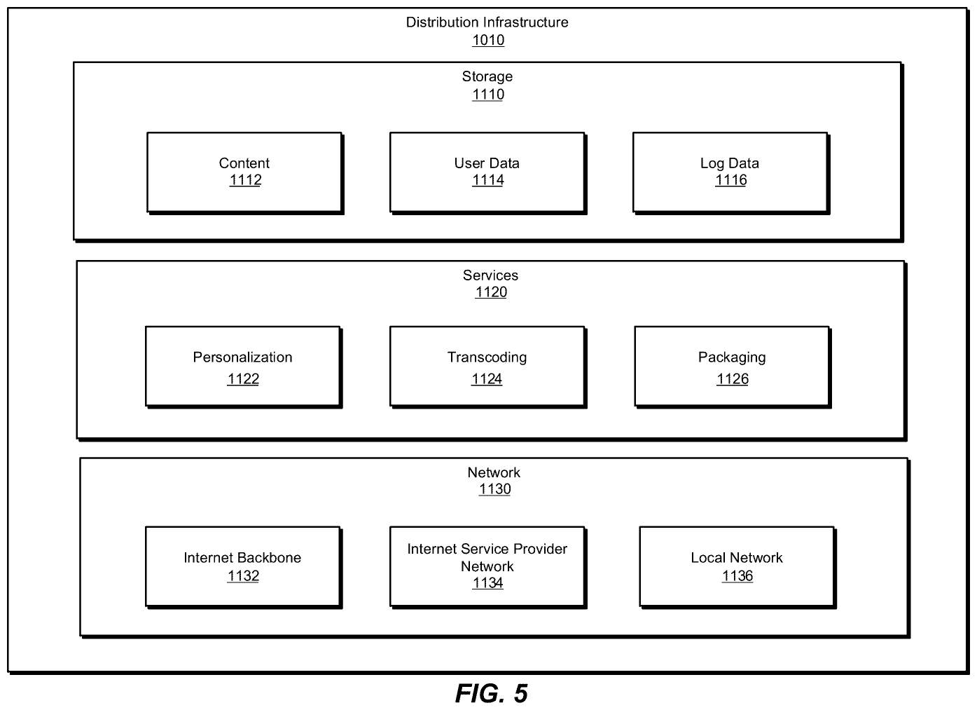

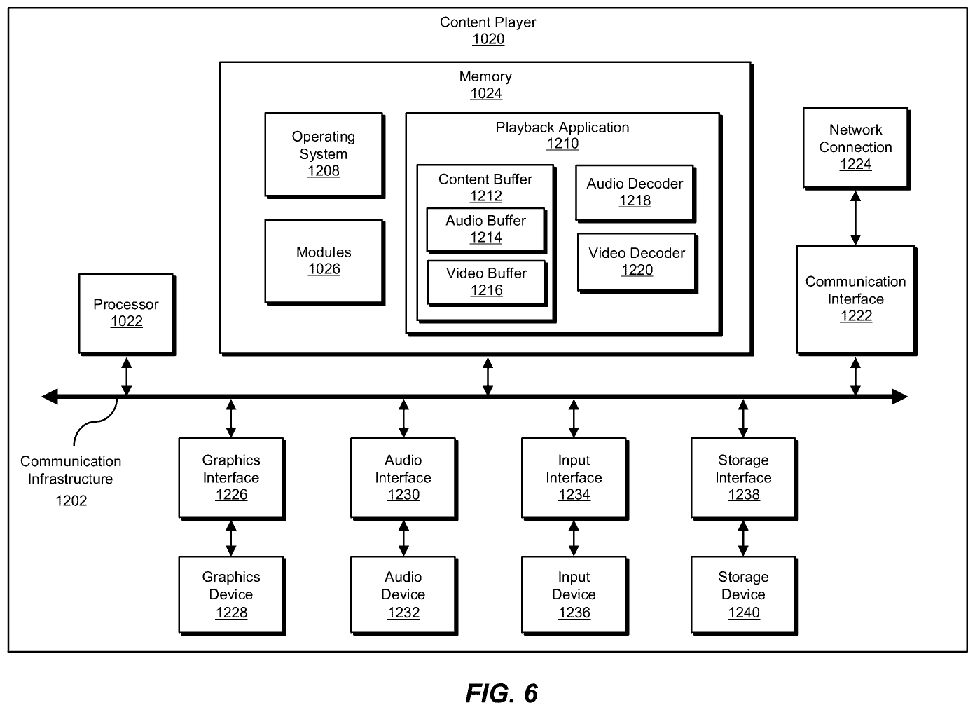

The following will provide, with reference to FIG. 4, detailed descriptions of exemplary ecosystems in which content is provisioned to end nodes and in which requests for content are steered to specific end nodes. The discussion corresponding to FIGS. 5 and 6 presents an overview of an exemplary distribution infrastructure and an exemplary content player used during playback sessions, respectively. These exemplary ecosystems and distribution infrastructures are implemented in any of the embodiments described above with reference to FIGS. 1-3.

FIG. 4 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 4 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 4 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 5 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 may store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Transcoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 5, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 6 is a block diagram of an exemplary implementation of content player 1020 of FIG. 4. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 6, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 includes, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and output the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 6, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIG. 6 need not be present to practice the embodiments described and/or illustrated herein. The devices and subsystems referenced above are also interconnected in different ways from that shown in FIG. 6. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A system comprising:
tiered storage media that includes a high-performance tier and a low-performance tier configured to store data corresponding to applications that are running on compute nodes and are agnostic to the high-performance tier and the low-performance tier; and
circuitry communicatively coupled to the tiered storage media, wherein the circuitry is configured to:
implement a storage layer comprising a data movement engine and a unified storage interface;
transparently transfer, by the data movement engine, a portion of the data between the high-performance tier and the low-performance tier based at least in part on a storage policy applied to the tiered storage media; and
provide, by the unified storage interface, at least one of the applications with access to the portion of the data.

2. The system of claim 1, wherein the at least one of the applications is unaware of the transparent transfer of the portion of the data between the high-performance tier and the low-performance tier.

3. The system of claim 1, wherein the unified storage interface:
receives, from the at least one of the applications, a request to read the portion of the data via a standard protocol;
obtains the portion of the data from the tiered storage media; and
transmits the portion of the data to the at least one of the applications via a network to satisfy the request.

4. The system of claim 3, wherein the unified storage interface initiates the transmission of the portion of the data upon determining that the at least one of the applications is authorized to access the portion of the data.

5. The system of claim 1, wherein:
the unified storage interface:
receives, from the at least one of the applications, a request to write an additional portion of the data to the tiered storage media via a standard protocol; and
provides the request to the data movement engine; and
the data movement engine writes the additional portion of the data to the tiered storage media to satisfy the request.

6. The system of claim 1, wherein the storage layer further comprises a provisioning engine that:
automatically provisions, by the provisioning engine, an area of the tiered storage media for the at least one of the applications based at least in part on characteristics of the at least one of the applications; and
automatically provisions, by the provisioning engine, another area of the tiered storage media for another one of the applications based at least in part on characteristics of the another one of the applications.

7. The system of claim 6, wherein the data movement engine:
stores a subset of the data corresponding to the at least one of the applications in the area of the tiered storage media; and
stores another subset of the data corresponding to the another one of the applications in the another area of the tiered storage media.

8. The system of claim 1, wherein the data movement engine:
monitors usage patterns of the portion of the data; and
transparently transfers the portion of the data from the high-performance tier to the low-performance tier or from the low-performance tier to the high-performance tier based at least in part on the storage policy, usage patterns of the portion of the data, and one or more workload considerations of the at least one of the applications.

9. The system of claim 1, wherein:
the storage layer comprises a metadata manager; and
the circuitry is further configured to:
generate, by the metadata manager, metadata associated with the portion of the data;
store, by the metadata manager, the metadata at multiple storage devices to ensure high availability of the portion of the data; and
locate, by the unified storage interface or the data movement engine, the portion of the data based at least in part on the metadata.

10. The system of claim 9, wherein the metadata identifies at least one of:
a current location at which the portion of the data is stored in the tiered storage media;
a state of the portion of the data; or
an access history of the portion of the data.

11. The system of claim 1, wherein:
the storage layer further comprises an analytics engine and a dashboard interface; and
the circuitry is further configured to:
aggregate, by the analytics engine from multiple agents running on the compute nodes, metadata associated with operations performed in connection with the portion of the data; and
provide the metadata for presentation via the dashboard interface.

12. A computer-implemented method comprising:
implementing, by circuitry, a storage layer in a tiered storage media that includes a high-performance tier and a low-performance tier;
storing, by a data movement engine of the storage layer in the tiered storage media, data corresponding to applications that are running on compute nodes and are agnostic to the high-performance tier and the low-performance tier;
transparently transferring, by the data movement engine, a portion of the data between the high-performance tier and the low-performance tier based at least in part on a storage policy applied to the tiered storage media; and
providing, by a unified storage interface of the storage layer, at least one of the applications with access to the portion of the data.

13. The computer-implemented method of claim 12, wherein the at least one of the applications is unaware of the transparent transfer of the portion of the data between the high-performance tier and the low-performance tier.

14. The computer-implemented method of claim 12, wherein providing the at least one of the application with access to the portion of the data comprises:
receiving, by the unified storage interface from the at least one of the applications, a request to read the portion of the data via a standard protocol;
obtaining the portion of the data from the tiered storage media; and
transmitting the portion of the data to the at least one of the applications via a network to satisfy the request.

15. The computer-implemented method of claim 14, wherein transmitting the portion of the data to the at least one of the applications comprises initiating the transmission of the portion of the data upon determining that the at least one of the applications is authorized to access the portion of the data.

16. The computer-implemented method of claim 12, further comprising:
receiving, by the unified storage interface from the at least one of the applications, a request to write an additional portion of the data to the tiered storage media via a standard protocol;
providing, by the unified storage interface, the request to the data movement engine; and
writing, by the data movement engine, the additional portion of the data to the tiered storage media to satisfy the request.

17. The computer-implemented method of claim 12, further comprising:
automatically provisioning, by a provisioning engine of the storage layer, an area of the tiered storage media for the at least one of the applications based at least in part on characteristics of the at least one of the applications; and
automatically provisioning, by the provisioning engine, another area of the tiered storage media for another one of the applications based at least in part on characteristics of the another one of the applications.

18. The computer-implemented method of claim 17, further comprising:
storing, by the data movement engine, a subset of the data corresponding to the at least one of the applications in the area of the tiered storage media; and
storing, by the data movement engine, another subset of the data corresponding to the another one of the applications in the another area of the tiered storage media.

19. The computer-implemented method of claim 12, further comprising:
monitoring, by the data movement engine, usage patterns of the portion of the data; and
transparently transferring, by the data movement engine, the portion of the data from the high-performance tier to the low-performance tier or from the low-performance tier to the high-performance tier based at least in part on the storage policy, usage patterns of the portion of the data, and one or more workload considerations of the at least one of the applications.

20. A non-transitory computer-readable medium comprising one or more computer-executable instructions that, when executed by circuitry of a computing device, cause the computing device to:
implement a storage layer in a tiered storage media that includes a high-performance tier and a low-performance tier;
store, by a data movement engine of the storage layer in the tiered storage media, data corresponding to applications that are running on compute nodes and are agnostic to the high-performance tier and the low-performance tier;
transparently transfer, by the data movement engine, a portion of the data between the high-performance tier and the low-performance tier based at least in part on a storage policy applied to the tiered storage media; and
provide, by a unified storage interface of the storage layer, at least one of the applications with access to the portion of the data.
